(19) United States
(12) Patent Application Publication
(10) Pub. No.: US 2006/0179173 A1
(43) Pub. Date: Aug. 10, 2006

(54) Method and system for cache utilization by prefetching for multiple DMA reads

(76) Inventor: John William Bockhaus, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,830

(22) Filed: Feb. 2, 2005

(51) Int. Cl. G06F 13/28

(52) U.S. Cl. 710/22

(57) ABSTRACT

System and method of memory utilization in a computer system are described. In one embodiment, the method comprises storing a DMA transaction received from an entity in a request address first-in, first out buffer (“RAF”); determining whether a first DMA transaction stored in the RAF is a read request; and responsive to a determination that the first DMA transaction is a read request, issuing at least one prefetch memory request in connection with the read request; otherwise, forgoing issuance of at least one prefetch memory request in connection with the first DMA transaction and determining whether a next DMA transaction stored in the RAF is a read request.

### CROSS-REFERENCE TO RELATED APPLICATION(S)

This application discloses subject matter related to the subject matter disclosed in the following commonly owned co-pending U.S. patent applications: (i) “METHOD AND SYSTEM FOR CACHE UTILIZATION BY LIMITING NUMBER OF PENDING CACHE LINE REQUESTS,” filed ______; application No. ______ (Docket No. 200314522-1), in the name(s) of: John W. Bockhaus; (ii) “METHOD AND SYSTEM FOR CACHE UTILIZATION BY LIMITING PREFETCH REQUESTS,” filed ______; application No. ______ (Docket No. 200314523-1), in the name(s) of: John W. Bockhaus and David Binford; and (iii) “METHOD AND SYSTEM FOR PREVENTING CACHE LINES FROM BEING FLUSHED UNTIL DATA STORED THEREIN IS USED,” filed ______; application No. ______ (Docket No. 200314524-1), in the name(s) of: John W. Bockhaus and David Binford; all of which are incorporated by reference herein.

### BACKGROUND

Today's processors are more powerful and faster than ever. As a result, even memory access times, typically measured in tens of nanoseconds, can be an impediment to a processor's running at full speed. Generally, the CPU time of a processor is the sum of the clock cycles used for executing instructions and the clock cycles used for memory access. While modern processors have improved greatly in terms of instruction execution time, the access times of reasonably-priced memory devices have not similarly improved.

A common method of compensating for memory access latency is memory caching. Memory caching takes advantage of the inverse relationship between the capacity and the speed of a memory device; that is, a larger (in terms of storage capacity) memory device is generally slower than a smaller memory device. Additionally, slower memories are less expensive, and are therefore more suitable for use as a portion of mass storage, than are more expensive, smaller, and faster memories.

In a caching system, memory is arranged in a hierarchical order of different speeds, sizes, and costs. For example, a small, fast memory, usually referred to as a “cache memory”, is typically placed between a processor and a larger, but slower, main memory. The cache memory has the capacity to store only a small subset of the data stored in the main memory. The processor needs only a certain, small amount of the data from the main memory to execute individual instructions for a particular application. The subset of memory is chosen based on an immediate relevance based on well-known temporal and spacial locality theories. This is analogous to borrowing only a few books at a time from a large collection of books in a library to carry out a large research project. Just as research may be as effective and even more efficient if only a few books at a time are borrowed, processing of a program is efficient if a small portion of the entire data stored in main memory is selected and stored in the cache memory at any given time.

An input/output (“I/O”) cache memory located between main memory and an I/O controller (“IOC”) will likely have different requirements than a processor cache memory, as it will typically be required to store more status information for each line of data, or “cache line”, than a processor cache memory. In particular, an I/O cache will need to keep track of the identity of the particular one of a variety of I/O devices requesting access to and/or having ownership of a cache line. The identity of the current requester/owner of the cache line may be used, for example, to provide fair access. Moreover, an I/O device may write to only a small portion of a cache line. Thus, an I/O cache memory may be required to store status bits indicative of which part of the cache line has been written or fetched. Additionally, one or more bits will be used to indicate line state of the corresponding cache line; e.g., private, current, allocated, clean, dirty, being fetched, etc. Still further, in an I/O cache, there is no temporal locality; that is, the data is used just once. As a result, an I/O cache does not need to be extremely large and functions more like a buffer to hold data as it is transferred from main memory to the I/O device and vice versa.

As I/O cards become faster and more complex, they can issue a greater number of direct memory access (“DMA”) requests and have more DMA requests pending at one time. The IOC, which receives these DMA requests from I/O cards and breaks up each into one or more cache line-sized requests to main memory, generally has a cache to hold the data that is fetched from main memory in response to each DMA request, but the amount of data that can be stored in the cache is fixed in size and is a scarce resource on the IOC chip.

When the IOC attempts to access a memory location in response to a DMA request from an I/O card, it first searches its cache to determine whether it already has a copy of the requested data stored therein. If not, the IOC attempts to obtain a copy of the data from main memory.

As previously indicated, when an IOC fetches data from main memory in response to a DMA request from an I/O card, it needs to put that data into its cache when the data is delivered from memory. If the cache is full (i.e., if there are no empty cache lines available), the new data may displace data stored in the cache that has not yet been used. This results in a performance loss, as the data that is displaced must subsequently be refetched from main memory.

I/O transfers tend to be long bursts of data that are linear and sequential in fashion. Prefetch data techniques allow I/O subsystems to request data stored in memory prior to an I/O device's need for the data. By prefetching data ahead of data consumption by the device, data can be continuously sent to the device without interruption, thereby enhancing I/O system performance. The amount of data that is prefetched in this manner for a single DMA transaction is referred to as “prefetch depth.” The “deeper” the prefetch, the more data that is fetched before the data from the first request has been consumed.

However, some DMA requests, in particular, Peripheral Component Interconnect (“PCI”) DMA reads, are speculative by nature. This is due to the fact that only the beginning address, but not the length, of the data is specified in a PCI DMA read request. Hence, a PCI DMA read will use prefetch operations to fetch data that the IOC “guesstimates” that the I/O device will require before that data is actually requested by the device. In contrast, PCIX standard DMA reads specify both a starting address and a length of the data to be read and are therefore nonspeculative. In one prior art embodiment, a prefetch machine is used to predict future requests based on a current request and keeps track of memory requests that have already been initiated and queued.

As previously indicated, IOCs are typically able to service only one or two DMA requests at a given time. This is not sufficient to provide enough bandwidth for the faster, more complex I/O cards currently available.

### SUMMARY

One embodiment is a memory utilization method in a computer system. The method comprises storing a DMA transaction received from an entity in a request address first-in, first out buffer (“RAF”); determining whether a first DMA transaction stored in the RAF is a read request; and responsive to a determination that the first DMA transaction is a read request, issuing at least one prefetch memory request in connection with the read request; otherwise, forgoing issuance of at least one prefetch memory request in connection with the first DMA transaction and determining whether a next DMA transaction stored in the RAF is a read request.

Another embodiment is a memory utilization method in a computer system. The method comprises, responsive to receipt of a DMA transaction from an entity, storing the DMA transaction in a request address first-in, first out buffer (“RAF”), wherein DMA transactions are stored in the RAF in an order in which they are received; initializing a pointer to point to a first entry of the RAF; determining whether a DMA transaction stored in an entry of the RAF to which the pointer points is a DMA read request; and responsive to a determination that the DMA transaction stored in an entry of the RAF to which the pointer points is a DMA read request, issuing at least one prefetch memory request in connection with the DMA read request; otherwise, forgoing issuance of at least one prefetch memory request in connection with the DMA transaction stored in the entry of the RAF to which the pointer points and advancing the pointer to point to a next entry of the RAF.

Another embodiment is a memory utilization system in a computer. The system comprises cache means for storing data in connection with DMA transactions; means responsive to receipt of a DMA transaction from the I/O card for storing the DMA transaction in a request address first-in, first out buffer (“RAF”); means for determining whether a first DMA transaction is a DMA read request; and means responsive to a determination that the first DMA transaction is a DMA read request, issuing at least one prefetch memory request in connection with the read request and otherwise forgoing issuance of at least one prefetch memory request in connection with the first DMA transaction and determining whether a next DMA transaction stored in the RAF is a DMA read request.

Another embodiment is a system for prefetching for multiple DMA reads in a computer. The system comprises a DMA sequencer including logic for sequencing through prefetch memory requests associated with a DMA transaction, wherein each prefetch memory request corresponds to a cache line of a cache memory; a request address first-in, first-out buffer (“RAF”) for storing DMA transactions received from an entity in an order in which they are received; a prefetch register associated with the entity for storing information regarding a prefetch request currently being processed; and pointer control logic for controlling a position of a prefetch pointer to the RAF, the pointer control logic for causing the prefetch pointer to point to a valid DMA read in the RAF and then to advance to a next valid DMA read in the RAF when processing of a prefetch associated with the valid DMA read has been completed.

Another embodiment is a computer-readable medium operable with a computer for memory utilization in a computer system. The medium has stored thereon instructions executable by the computer responsive to receipt of a DMA transaction from an entity for storing the DMA transaction in a request address first-in, first out buffer (“RAF”); instructions executable by the computer for determining whether a first DMA transaction is a DMA read request; and instructions executable by the computer responsive to a determination that the first DMA transaction is a DMA read request for issuing at least one prefetch memory request in connection with the read request and otherwise forgoing issuance of at least one prefetch memory request in connection with the first DMA transaction and determining whether a next DMA transaction stored in the RAF is a DMA read request.

### BRIEF DESCRIPTION OF THE DRAWINGS

FIG. 1A is a block diagram of an exemplary I/O cache;

FIG. 1B is a block diagram of a computer system in accordance with one embodiment;

FIG. 1C is a block diagram of an I/O controller of the computer system of FIG. 1B;

FIG. 2 is a block diagram of an I/O interface subsystem of the I/O controller of FIG. 1C;

FIG. 3 is a more detailed block diagram of the I/O interface subsystem of FIG. 2;

FIG. 4 is a block diagram of a system for prefetching for multiple DMA reads in accordance with one embodiment; and

FIG. 5 is a flowchart illustrating operation of a method of one embodiment for utilizing the cache of the I/O controller of FIG. 1C.

### DETAILED DESCRIPTION OF THE DRAWINGS

In the drawings, like or similar elements are designated with identical reference numerals throughout the several views thereof, and the various elements depicted are not necessarily drawn to scale.

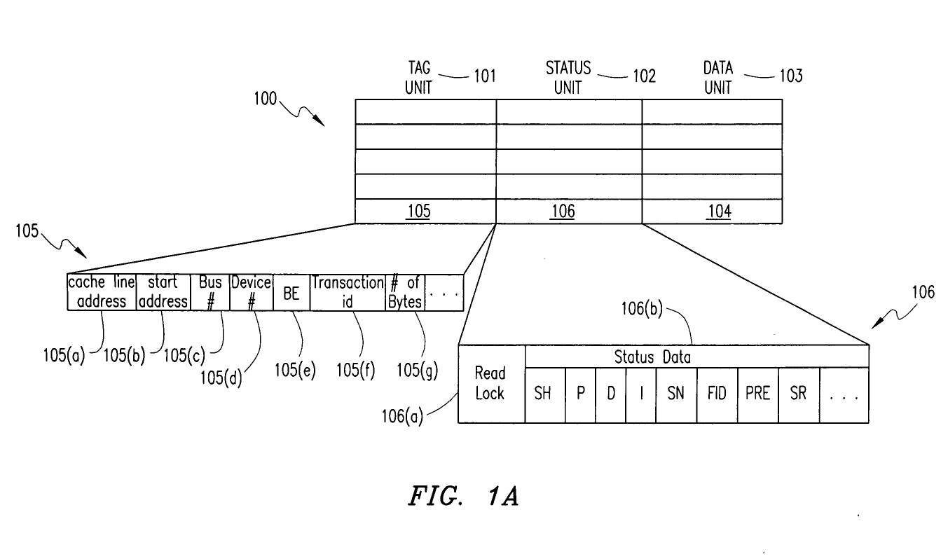

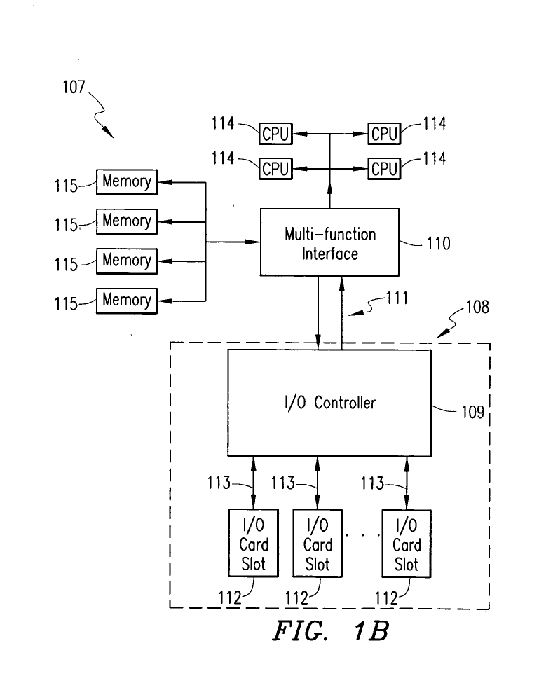

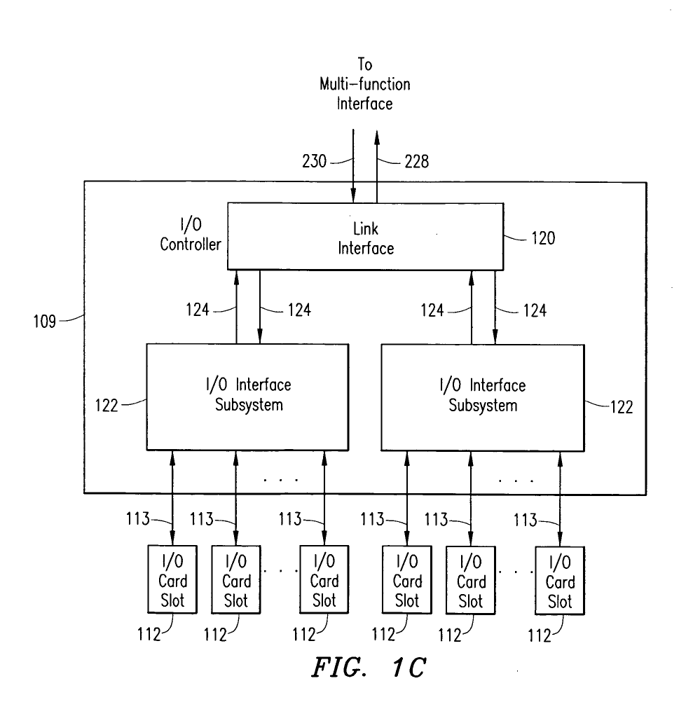

FIG. 1A is a block diagram of an exemplary I/O cache 100. As illustrated in FIG. 1A, the cache 100 comprises a tag unit 101, a status unit 102, and a data unit 103. The data unit 103 comprises a number of cache lines, such as the cache line 104, each of which is preferably 128 bytes long. Each cache line has associated therewith a tag line that is stored in the tag unit 101, such as the tag line 105, and a status line that is stored in the status unit 102, such as the status line 106.

As shown in FIG. 1A, each tag line of the tag unit 102 can include the following data:
cache line address 105(a) the address of the associated cache line in the data unit 103;
start address 105(b) the address of the initial block of data of the associated cache line;
bus # 105(c) identifies the PCI bus requesting the cache line;
device # 105(d) identifies the device requesting the cache line data;
byte enable 105(e) identifies the bytes to be transferred and the data paths to be used to transfer the data;
transaction ID 105(f) identifies a transaction initiating the DMA read request; and
number of bytes 105(g) indicates the number of bytes subject to the read request.

The tag unit 101 stores all of the above-identified information in part to identify the originator and the originating request.

As also shown in FIG. 1A, each status line of the status unit 102 can include the following data:
read lock 106(a) a variable indicating that an I/O device has requested the corresponding cache line and the cache line has not yet been returned to the requesting device;
status data 106(b) status data can indicate one or more of the following cache line states:
shared (“SH”) the cache line is present in the cache and contains the same value as in main memory;
private (“P”) the cache line is present in the cache and the cache has read and write access to the cache line;
dirty (“D”) the cache has the data marked private and the value has been updated only in the cache;
invalid (“I”) the associated cache line does not represent the current value of the data;
snapshot (“SN”) the associated cache line represents a value that was current at the time a read request was made and was snooped thereafter;
fetch-in-progress (“FIP”) the associated cache line is being fetched;
prefetch (“PRE”) the cache line is being prefetched.

FIG. 1B is a block diagram of a computer system 107 according to one embodiment. As illustrated in FIG. 1B, the computer system 107 includes an I/O subsystem 108 comprising at least one IOC 109 that communicates with a multi-function interface 110 via a high-speed link 111. Each of a plurality of I/O card slots 112 for accommodating I/O cards is connected to the IOC 109 via an I/O bus 113. The multi-function interface 110 provides inter alia an interface to a number of CPUs 114 and main memory 115.

FIG. 1C is a high level block diagram of the IOC 109. A link interface block 120 connects to one or more I/O interface subsystems 122 via internal, unidirectional buses, represented in FIG. 1C by buses 124. The link interface block 120 further connects to the multi-function interface 110 via the high speed link 111, which, as shown in FIG. 1C, comprises an inbound (from the perspective of the interface 110) bus 228 and an outbound (again, from the perspective of the interface 110) bus 230.

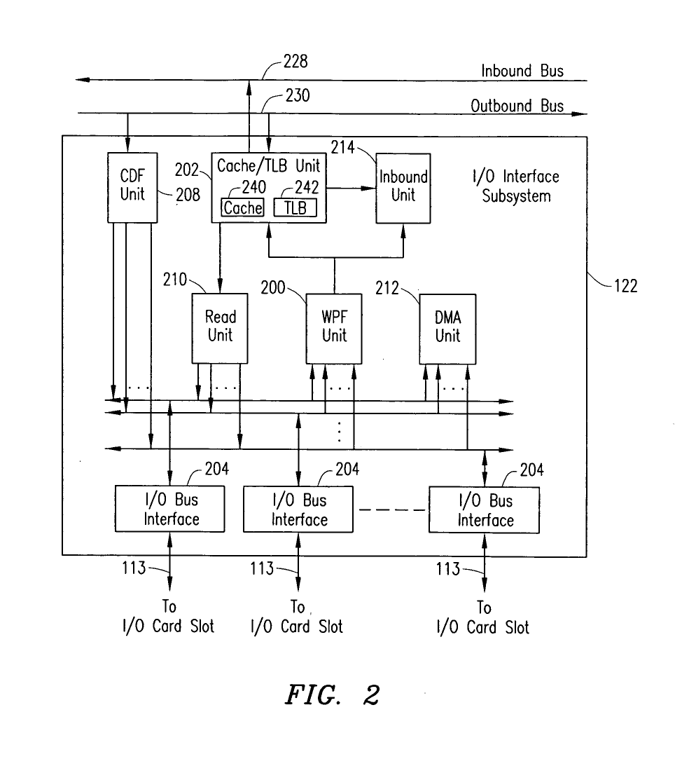

FIG. 2 is a more detailed block diagram of one of the I/O interface subsystems 122. The I/O interface subsystem 122 includes a write-posting FIFO (“WPF”) unit 200, a cache and Translation Lookaside Buffer (“Cache/TLB”) unit 202, and a plurality of I/O bus interfaces 204. Each of the I/O bus interfaces 204 provides an interface between one of the I/O buses 113 and the I/O interface subsystem 122. The I/O interface subsystem 122 further includes a Control-Data FIFO (“CDF”) unit 208, a Read unit 210, and a DMA unit 212, for purposes that will be described in greater detail below.

The Cache/TLB unit 202 includes a cache 240 and a TLB 242. The cache 240 contains 96 fully-associative entries, each 128-bytes wide. In one embodiment, a substantial amount of status information is available on each cache line including line state, bytes written, number of writes outstanding to line, which I/O bus the line is bound to, and more. For example, it will be recognized that the cache embodiment of FIG. 1A may be used in some implementations of the I/O interface subsystem 122 for purposes of the present disclosure.

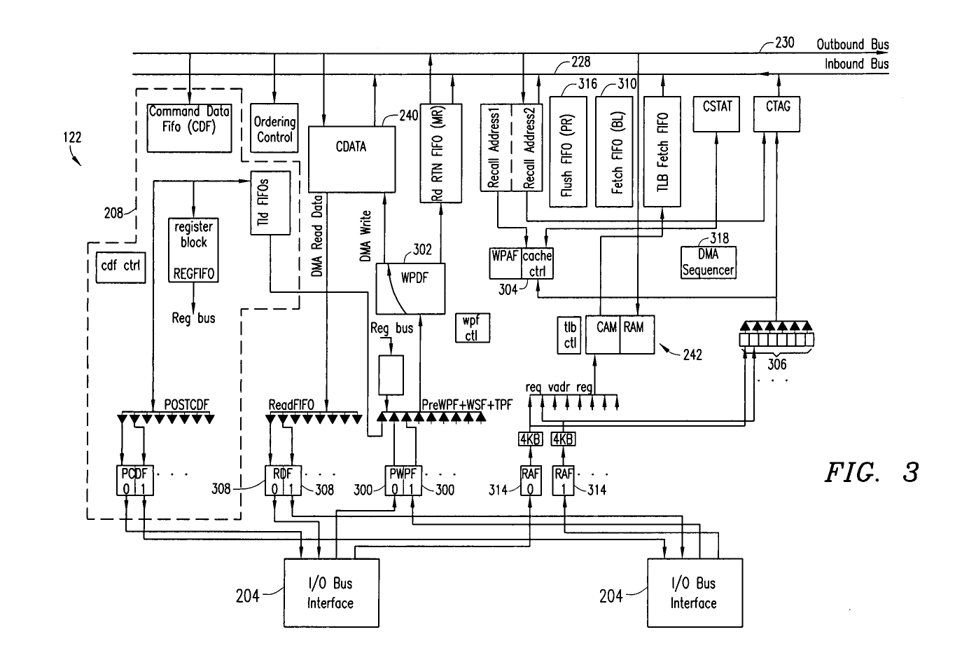

As used herein, “bottom end” will be used to refer to the end of a device or unit nearest the I/O card slots 112, while “upper end” will be used to refer to the end of a device or unit nearest the multi-function interface 110. Accordingly, in one embodiment, the bottom end of each of the CDF unit 208, Read unit 210, WPF unit 200, and DMA unit 212, includes a separate structure for each of the I/O bus interfaces 204 such that none of the I/O buses 113 has to contend with any of the others to get buffered into the IOC 109. All arbitration between the I/O buses 113 occurs inside of each of the units 200, 208, 210, and 212, to coalesce or divide traffic into the single resources higher up (i.e., closer to the multi-function interface 110). For instance, a DMA write address will come up through one of the I/O bus interfaces 204 and be stored in a corresponding address register (not shown) in the DMA unit 212. Referring now also to FIG. 3, data following the address will go into a dedicated one of a plurality of pre-WPFs 300 in the WPF unit 200. Each pre-WPF 300 is hardwired to a corresponding one of the I/O buses 113. When the data reaches the head of the pre-WPF 300, arbitration occurs among all of the pre-WPFs, a cache entry address (“CEA”) is assigned to the write, and the data is forwarded from the pre-WPF into a main write-posting data FIFO (“WPDF”) 302.

FIFOs that interface with inbound and outbound buses 228, 230, are single FIFOs and are not divided by I/O buses 113. FIFOs in the inbound unit 214 handle various functions including TLB miss reads and fetches and flushes from the cache 240.

The IOC 109 is the target for all PCI memory read transactions to main memory 115. A PCI virtual address will be translated into a 44-bit physical address by the TLB 242, if enabled for that address, and then forwarded to a cache controller 304 through request physical address registers 306. If there is a hit, meaning that the requested data is already in the cache 240, the data will be immediately returned to the requesting I/O bus though one of a plurality of Read Data FIFOs 308 dedicated thereto. If there is no hit, an empty cache line entry will be allocated to store the data and an appropriate entry will be made in a Fetch FIFO 310. If prefetch hints indicate that additional data needs to be fetched, the new addresses will be generated and fetched from main memory in a similar manner.

For fixed-length PCIX reads, up to eight DMA read/write requests can be in each of a plurality of a Request Address FIFOs (“RAFs”) 314. To minimize the start-up latency on DMA reads, there is a preread function that begins processing the next read in each RAF 314 before the current read has completed. This includes translating the address using the TLB 242 and issuing fetches for the read. When the current DMA read has completed its prefetches, if there is another read behind it in the RAF 314, prefetches will be issued for that read. The original read stream continues; when it completes, the first few lines of the next stream should already be in the cache 240.

In general, the cache 240 stays coherent, allowing multiple DMA sub-line reads to reference the same fetched copy of a line. Forward progress during reads is guaranteed by “locking” a cache entry that has been fetched until it is accessed from the I/O buses 113. A locked entry does not mean that ownership for the cache line is locked; it simply means that a spot is reserved in the cache 240 for that data until it is accessed from PCI. Ownership of the line could still be lost due to a recall. Only the same PCI entity that originally requested the data will be able to access it. Any additional read accesses to that cache line by another PCI entity would be retried until the original PCI entity has read the data, at which point the cache line is unlocked. A line is considered fetched when it is specifically requested by a PCI transaction, even if the transaction was retried. A line is considered pre-fetched if it is requested by the cache block as the result of hit bits associated with a fetched line. Cache lines that are prefetched are not locked and could be flushed before they are actually used if the cache is thrashing. The PCI specification guarantees that a master whose transaction is retried will eventually repeat the transaction. The cache size has been selected to ensure that a locked cache line is not a performance issue and does not contribute to the starvation of some PCI devices.

The IOC 109 maintains a timeout bit on each locked cache line. This bit is cleared whenever the corresponding cache line is accessed and is flipped each time a lock_timeout timer expires. Upon transition of the timeout bit from one to zero, the line is flushed. This is a safeguard to prevent a cache line from being locked indefinitely.

There is a bit for each line that indicates that a fetch is in progress with respect to that line. If read data returns on the link for a line that does not have the fetch-in-progress bit set, the data will not be written into the cache for that transaction and an error will be logged. There is also a timer on each fetch in progress to prevent a line from becoming locked indefinitely.

With regard to DMA writes, if the entry at the head of the WPDF 302 is a write to memory, a cache line has already been reserved for the data. A write-posting address FIFO (“WPAF”) holds the CEA value. The status of the cache line indicated by the CEA is checked to determine whether ownership of the line has been obtained. Once ownership is received, the data is copied from the WPDF 302 into the cache 240. The status bits of the cache line are then updated. If ownership has not yet been received, the status of the cache line is monitored until ownership is obtained, at which point the write is performed.

To keep a few cache lines available for processing DMA requests, a cache replacement algorithm (“CRA”) is employed. If the CRA makes a determination to flush a line, the cache line status will be checked and the CEA written to a flush FIFO 316 to make room for the next transaction.

Lines may also be flushed automatically and there are separate auto-flush hint mechanisms for both reads and writes. For connected DMA reads, there are two different types of auto flush. In the default case, a flush occurs when the last byte of the cache line is actually read on PCI. The second type is an aggressive auto-flush mode that can be enabled by setting a hint bit with the transaction. In this mode, the line is flushed from the cache 240 as soon as the last byte is transferred to the appropriate one of the RDFs 308. For fixed-length DMA reads, the aggressive auto-flush mode is always used.

There are also two types of auto-flushes for writes. The default mode causes a line to be flushed with the last byte written to a cache line from the WPDF 302. The second mode, enabled via a hint bit with the transaction, is an aggressive auto-flush. In this mode, the line is flushed from the cache 240 as soon as there are no more outstanding writes to that cache line in the WPDF 302.

Continuing to refer to FIG. 3, each of the I/O buses 113 can have up to eight requests queued up in its RAF 314. A DMA sequencer 318 of the DMA unit 212 can be working on one read, one write, and one preread for each I/O bus. Each read/write can be for a block of memory up to 4 KB. A write can pass a read if the read is not making progress.

DMA latency is hidden as follows. For DMA reads, prefetching is used to minimize the latency seen by the I/O cards. A hint indicating prefetch depth is provided with the transaction and is defined by software. As previously indicated, for a DMA write, the write data goes from the I/O bus into a corresponding one of the pre-WPFs 300 and then into the WPDF 302. The FIFOs 300, 302, are large enough to hide some of the latency associated with a DMA write request.

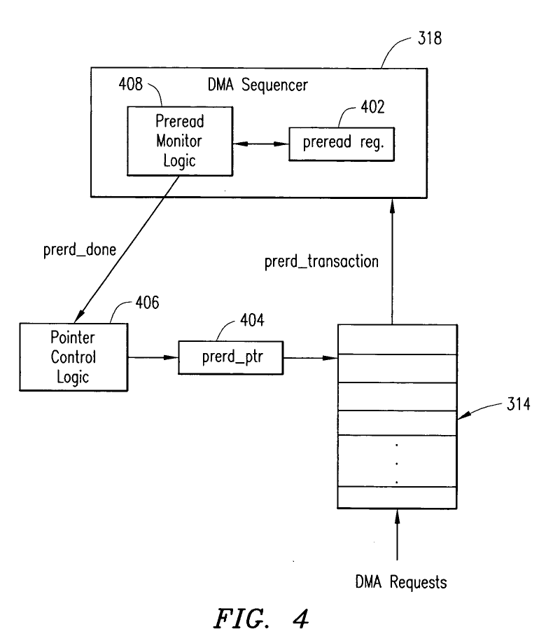

FIG. 4 is a block diagram of an embodiment 400 comprising a preread function for prefetching for multiple DMA reads. As previously noted, the DMA sequencer 318 contains logic to sequence through the memory requests associated with each DMA transaction. Each memory request corresponds to a cache line of the cache 240 (FIG. 2). In accordance with one embodiment, each I/O bus has associated therewith a preread register 402 in the DMA sequencer 318. The preread register 402 tracks which read request to which a preread pointer (“prerd_ptr”) 404 points in the RAF 314 of the I/O bus and for which a “preread”, comprising one or more prefetches, is being performed. In particular, the preread register 402 contains information regarding the read request currently being processed. Pointer control logic 406 controls the position of the prerd_ptr 404 and causes it to point to first a valid DMA read in the RAF 314 and then to advance to the next valid DMA read in the RAF when all of the prefetches for the previous DMA read have been issued. Preread monitor logic 408 in the DMA sequencer 318 detects if a new preread request is ready, loads the read request pointed to by the prerd_ptr 404 into the preread register 402 (via “prerd_transaction”), and signals the RAF and pointer control logic 406 when the all of the prefetches for the current preread have been issued (via “prerd_done”), whether or not the requested read data has been returned from main memory or sent to the requesting I/O card.

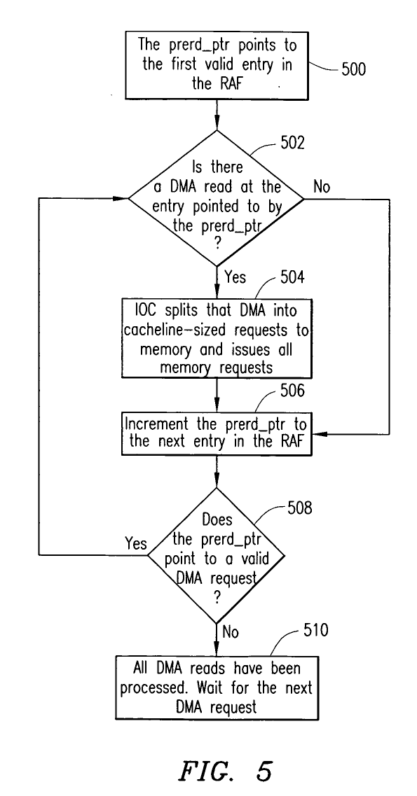

FIG. 5 is a flowchart of the operation of one embodiment of a preread function for prefetching for multiple DMA reads. It will be assumed for the sake of example that at the beginning of the process illustrated in FIG. 5, the RAF 314 is empty and the prerd_ptr 404 is not pointing to any entry in the RAF. Subsequently, the I/O card issues one or more DMA reads and/or DMA writes (hereinafter collectively “DMA transactions”) and all of the DMA transaction requests are held in the order in which they were received in the RAF 314.

At this point, in block 500, the pointer control logic 406 sets the prerd_ptr 404 to point to a first valid entry in the RAF 314. In block 502, a determination is made whether the entry to which the prerd_ptr 404 points is a DMA read. If so, execution proceeds to block 504, in which a preread is performed for the DMA read; that is, IOC 109 splits the DMA read into cache line-sized prefetch requests to memory and issues all of the prefetch memory requests. Execution then proceeds to block 506. Similarly, if a negative determination is made in block 502, meaning that the entry pointed to by the prerd_ptr 404 is a DMA write, execution proceeds directly to block 506, thereby effectively “skipping” the DMA write and forgoing issuance of cache line-sized prefetch memory requests for the transaction.

In block 506, the pointer control logic 406 increments the prerd_ptr 404 to the next entry in the RAF 314. In block 508, a determination is made whether the entry pointed to by the prerd_ptr 404 contains a valid DMA transaction. If so, execution returns to block 502; otherwise, execution proceeds to block 510. In block 510, a determination is made that all prefetch memory requests for the current DMA read/write have been issued.

In summary, and as described with reference to FIGS. 4 and 5, the RAF 314 effectively functions as an “in-order log” for DMA requests. A separate data structure comprising the preread monitor logic 408 and the preread register 402 tracks which of these requests are reads. The pointer prerd_ptr 404 into the RAF 314 identifies the read request for which prefetches are currently being issued. When the prefetches for the read request pointed to by the prerd_ptr 404 have been issued, the pointer is incremented to the next read request in the RAF 314 and prefetch requests are issued for that read request. This continues on for all reads that have come in. It will be recognized that the prerd_ptr 404 may be incremented immediately upon issuance of all of the prefetches for the current read request; there is no need to wait to do so until the read data has come back from main memory or is sent to the requesting I/O card.

Any DMA write requests, which may be interspersed with the reads in the RAF 318, are skipped, such that the DMA read requests are permitted to issue prefetch requests out of order. Ordering is maintained between the DMA write requests and the DMA read requests because all of the DMA requests are serviced from the RAF 318, which functions as a sort of “in-order log”. In this manner, even though prefetch requests may be issued out-of-order, the DMA transactions are serviced in order according to their order in the RAF 318 via the normal mechanisms. As a result, all read data is sent to the requesting I/O card in the order in which it was requested. Additionally, all DMA writes enter the coherency domain before any subsequent DMA reads are completed. As a result, any “DMA Write A, DMA Read A” sequence will provide the write data to the subsequent read, even if the prefetch for the DMA read occurred before the DMA write. The out-of-order prefetches will not provide stale data to the IO card, because they are coherent in the system 107, and can be invalidated/recalled if their data changes in the system 107.

It will be recognized that the flowchart illustrated in FIG. 5 illustrates only how DMA transactions are processed in accordance with an embodiment. The sequence of events that is executed when the requested data is returned from main memory to the cache occur is outside the scope of the embodiments described herein and therefore will not described in greater detail. It should be noted, however, that all DMA reads will complete.

An implementation of the embodiments described herein thus provides method and system for efficient cache utilization by prefetching for multiple DMA reads. The embodiments shown and described have been characterized as being illustrative only; it should therefore be readily understood that various changes and modifications could be made therein without departing from the scope of the present invention as set forth in the following claims.

What is claimed is:

1. A memory utilization method in a computer system, the method comprising:
storing a DMA transaction received from an entity in a request address first-in, first-out buffer (“RAF”);
determining whether a first DMA transaction stored in the RAF is a read request; and
responsive to a determination that the first DMA transaction is a read request, issuing at least one prefetch memory request in connection with the read request; otherwise, forgoing issuance of at least one prefetch memory request in connection with the first DMA transaction and determining whether a next DMA transaction stored in the RAF is a read request.

2. The method of claim 1 further comprising:
responsive to a determination that the next DMA transaction is a read request, issuing at least one prefetch memory request in connection with the next DMA transaction; otherwise, forgoing issuance of at least one prefetch memory request in connection with the first DMA transaction and determining whether a next DMA transaction stored in the RAF is a read request.

3. The method of claim 1 further comprising determining whether a first DMA transaction is a valid transaction.

4. The method of claim 1 further comprising, responsive to receipt of a DMA transaction from the entity, dividing the received DMA transaction into a number of prefetch memory requests, wherein a size of each of the number of prefetch memory requests is equal to a size of a cache line of a cache memory of the computer system.

5. The method of claim 4 wherein the entity is an I/O device and the cache memory is an input/output (“I/O”) cache memory.

6. The method of claim 4 wherein the cache memory is a coherent cache memory.

7. The method of claim 1 wherein the first DMA transaction comprises a DMA read request.

8. The method of claim 1 wherein the first DMA transaction comprises a DMA write request.

9. A memory utilization method in a computer system, the method comprising:
responsive to receipt of a DMA transaction from an entity, storing the DMA transaction in a request address first-in, first out buffer (“RAF”), wherein DMA transactions are stored in the RAF in an order in which they are received;
initializing a pointer to point to an entry of the RAF;
determining whether a DMA transaction stored in the entry of the RAF to which the pointer points is a DMA read request; and
responsive to a determination that the DMA transaction stored in an entry of the RAF to which the pointer points is a DMA read request, issuing at least one prefetch memory request in connection with the DMA read request; otherwise, forgoing issuance of at least one prefetch memory request in connection with the DMA transaction stored in the entry of the RAF to which the pointer points and advancing the pointer to point to a next entry of the RAF.

10. The method of claim 9 further comprising:
responsive to a determination that the DMA transaction stored in the next entry of the RAF is a read request, issuing at least one prefetch memory request in connection with the read request stored in the next RAF entry.

11. The method of claim 9 further comprising determining whether the DMA transaction stored in an entry of the RAF to which the pointer points is valid.

12. The method of claim 9 further comprising, responsive to receipt of a DMA transaction from the entity, dividing the received DMA transaction into a number of cache line-sized prefetch memory requests, wherein a size of each of the number of prefetch memory requests is equal to a size of a cache line of a cache memory of the computer system.

13. The method of claim 12 wherein the entity is an I/O device and the cache memory is an input/output (“I/O”) cache memory.

14. The method of claim 12 wherein the cache memory is a coherent cache memory.

15. The method of claim 9 wherein the DMA transaction comprises a DMA read request.

16. The method of claim 9 wherein the DMA transaction comprises a DMA write request.

17. A memory utilization system in a computer, the system comprising:
cache means for storing data in connection with DMA transactions;
means responsive to receipt of a DMA transaction from the I/O card for storing the DMA transaction in a request address first-in, first out buffer (“RAF”);
means for determining whether a first DMA transaction is a DMA read request; and
means responsive to a determination that the first DMA transaction is a DMA read request, issuing at least one prefetch memory request in connection with the read request and otherwise forgoing issuance of at least one prefetch memory-request in connection with the first DMA transaction and determining whether a next DMA transaction stored in the RAF is a DMA read request.

18. The system of claim 17 further comprising:
means responsive to a determination that the next DMA transaction is a DMA read request for issuing at least one prefetch memory request in connection with the next DMA transaction; otherwise, forgoing issuance of at least one prefetch memory request in connection with the first DMA transaction and determining whether a next DMA transaction stored in the RAF is a DMA read request.

19. The system of claim 17 further comprising means for determining whether a first DMA transaction is a valid transaction.

20. The system of claim 17 further comprising means responsive to receipt of a DMA transaction from the entity for dividing the received DMA transaction into a number of cache line-sized prefetch memory requests.

21. The system of claim 17 wherein the entity is an I/O device and the cache memory is an input/output (“I/O”) cache memory.

22. The system of claim 17 wherein the cache memory is a coherent cache memory.

23. The system of claim 17 wherein the first DMA transaction comprises a DMA read request.

24. The system of claim 17 wherein the first DMA transaction comprises a DMA write request.

25. A system for prefetching for multiple DMA reads in a computer, the system comprising:
a DMA sequencer including logic for sequencing through prefetch memory requests associated with a DMA transaction, wherein each prefetch memory request corresponds to a cache line of a cache memory;
a request address first-in, first-out buffer (“RAF”) for storing DMA transactions received from an entity in an order in which they are received;
a prefetch register associated with the entity for storing information regarding a prefetch request currently being processed; and
pointer control logic for controlling a position of a prefetch pointer to the RAF, the pointer control logic for causing the prefetch pointer to point to a valid DMA read in the RAF and then to advance to a next valid DMA read in the RAF when processing of a prefetch associated with the valid DMA read has been completed.

26. The system of claim 25 further comprising prefetch monitor logic for detecting if a new prefetch request is ready, loading a prefetch to which the prefetch pointer points into the prefetch register, and signaling the RAF and pointer control logic when processing of a current prefetch request is completed.

27. The system of claim 25 further comprising an I/O controller for splitting a DMA read to which the prefetch pointer points into cache line-sized prefetch memory requests and issuing the cache line-sized prefetch memory requests.

28. The system of claim 25 wherein the entity is an I/O device and the cache memory is an input/output (“I/O”) cache memory.

29. The system of claim 25 wherein the cache memory is a coherent cache memory.

30. A computer-readable medium operable with a computer for memory utilization in a computer system, the medium having stored thereon:
instructions executable by the computer responsive to receipt of a DMA transaction from an entity for storing the DMA transaction in a request address first-in, first out buffer (“RAF”);
instructions executable by the computer for determining whether a first DMA transaction is a DMA read request; and
instructions executable by the computer responsive to a determination that the first DMA transaction is a DMA read request for issuing at least one prefetch memory request in connection with the read request and otherwise forgoing issuance of at least one prefetch memory request in connection with the first DMA transaction and determining whether a next DMA transaction stored in the RAF is a DMA read request.

31. The medium of claim 30 further having stored thereon instructions executable by the computer responsive to a determination that the next DMA transaction is a DMA read request for issuing at least one prefetch memory request in connection with the next DMA transaction; otherwise, forgoing issuance of at least one prefetch memory request in connection with the first DMA transaction and determining whether a next DMA transaction stored in the RAF is a DMA read request.

32. The medium of claim 30 further having stored thereon instructions executable by the computer for determining whether a first DMA transaction is a valid transaction.

33. The medium of claim 30 further having stored thereon instructions executable by the computer responsive to receipt of a DMA transaction from the entity for dividing the received DMA transaction into a number of cache line-sized prefetch memory requests.
